(19) United States
(12) Patent Application Publication
(10) Pub. No.: US 2016/0202893 A1
(43) Pub. Date: Jul. 14, 2016

(54) FREQUENCY CONVERTER

(71) Applicant: ABB Technology Oy, Helsinki (FI)

(72) Inventors: Harri Mustonen, Helsinki (FI); Vesa Tuomainen, Helsinki (FI); Tuomo Höysniemi, Helsinki (FI)

(21) Appl. No.: 14/938,161

(22) Filed: Nov. 11, 2015

(30) Foreign Application Priority Data
Nov. 26, 2014 (EP) 14194842.2

(51) Int. Cl. G06F 3/0484; G06F 3/0488; G06F 3/0481

(52) U.S. Cl. CPC G06F 3/04847; G06F 3/04817; G06F 3/0488

(57) ABSTRACT

A frequency converter comprising a display panel, wherein the display panel is adapted to display information relating to operation or to set up of the frequency converter as graphical icons.

### FIELD OF THE INVENTION

The present invention relates to frequency converters, and more particularly to frequency converters having a control panel.

### BACKGROUND OF THE INVENTION

Frequency converters are industrial devices which are used in different processes and automation systems for controlling the rotation of a motor. As a frequency converter may be used with different processes and for different purposes, the parameters of the frequency converter need to be set according to the specific use as the parameters configure the frequency converter in desired manner.

The parameters and selectable options relate, for example, to motor data from the motor plate of the controlled motor, such as nominal voltage and speed of the controlled motor. Further, the parameters can set the motor control principle, rotational speed limits, speed ramp times and switching frequency of the frequency converter, for example.

The parameters and information on the selected parameters together with operational data are shown and selected in the control panel of the frequency converter. The control panel includes buttons, touch screen or similar means for inputting commands from the user. Further, the control panel also includes a display device for presenting the selectable and selected parameters and data relating to the operation of the frequency converter. The operator of the frequency converter in the industrial process sets up the parameters of the frequency converter using the display device together with the inputting means.

The information displayed in the frequency converter while the frequency converter is in operation or is being set up is shown as text and electrical symbols together with numbers. As similar mass produced frequency converters are employed in wide variety of countries, different language versions are needed for different countries such that the operator of the device in the industrial environment is able to operate the device. The different language versions of the user interface software require translations and the constant updating as the user interface may be updated during the lifetime of the frequency converter. Further, as wide variety of different language versions of the software are required, the storage of the different versions is not feasible in the frequency converter itself due to large amount of memory capacity required for the different versions.

Similarly, when a frequency converter is provided from the factory or storage to a certain language area with a correct language version, the frequency converter may be exported to some other country from its original destination having different language requirements. The operators of the frequency converter are technically qualified industrial workers but are not necessarily used to work using a foreign language.

Further, when product is shipped across countries, the textual user interface of original country may cause permanent impression of lower quality in the receiving country. Icon based user interface help to keep the first product impression neutral or even resulting a higher perceived quality by the end user.

### BRIEF DESCRIPTION OF THE INVENTION

An object of the present invention is to provide a frequency converter so as to solve the above problem. The object of the invention is achieved by a frequency converter which is characterized by what is stated in the independent claim. The preferred embodiments of the invention are disclosed in the dependent claims.

The invention is based on the idea of using graphical icons in the display of the user interface of the frequency converter. The graphical icons are such that technically qualified operators are able to understand the symbols in the icons. The icons represent symbolically the operational data and parameters of the frequency converter.

An advantage of the frequency converter of the invention is that the maintenance of the software of the user interface is simpler as only one version is updated. Further, the number of stored product variants is smaller, as the product can be supplied and understood anywhere with the symbolic icons. The frequency converter of the invention can also be exported from its first origin without the need of updating the software.

### BRIEF DESCRIPTION OF THE DRAWINGS

In the following the invention will be described in greater detail by means of preferred embodiments with reference to the attached drawings, in which

FIG. 1 shows an example of the user interface of a frequency converter of the invention.

### DETAILED DESCRIPTION OF THE INVENTION

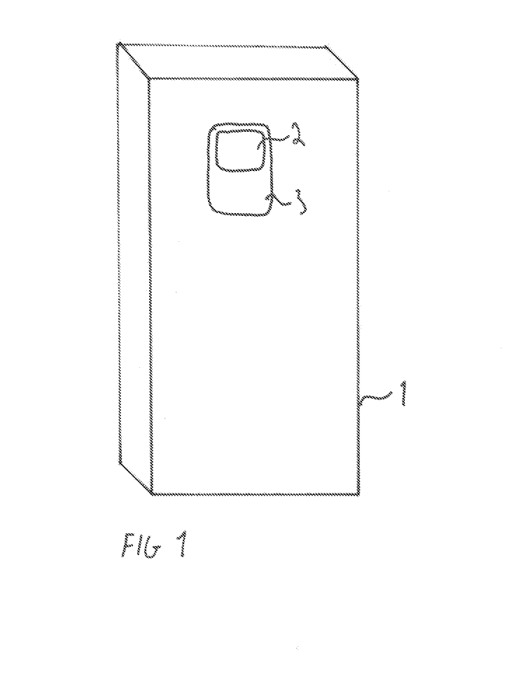

FIG. 1 shows an example of a user interface of the frequency converter of the invention. In the display of the user interface, information is displayed as numbers and graphical icons. According to the invention, the frequency converter 1 comprises a display panel 2. The display panel 2 is adapted to display information relating to operation of the frequency converter as graphical icons.

The display panel is a part of the user interface 3 of a frequency converter. The user interface also comprises buttons or other input means such that appropriate settings can be entered to the frequency converter. Further, the input means can be used to select the displayed information during the use of the frequency converter.

The used graphical icons are stored in the memory of the frequency converter. The memory can be accessed by a processor or similar processing means such that the processing means reads the graphical icons from the memory and controls the display to show the icons in desired manner. The processor of the user interface executes commands inputted by the user and gathers displayed information relating to the use of the frequency converter from other parts of the frequency converter. Such gathered and displayed information is, for example, output frequency and switching frequency of the frequency converter. The user actions may change the displayed information. Therefore the processor of the user interface reads required graphical symbols from a memory and displays them according to given instructions. For example, the user may select to view output frequency of the frequency converter instead of displayed switching frequency. For this operation the user selects the information to be displayed using the user interface. The desired operation is commanded to the frequency converter using the user interface, and the processor of the user interface selects from the memory a graphical icon representing output frequency and reads the value of the output frequency from the frequency converter. After this information is read, the value and graphical symbol are shown in the display of the user interface.

The memory of the user interface includes the graphical icons or symbols indexed in such a way that the program of the processing means can read the correct graphical icon for displaying it on the display.

The displayed information may also contain text or abbreviations relating to values which are widely known for a technically qualified user. Such text may be, for example, “RPM”, “Volts”, “Hz”, etc.

During the setting of the parameters the display of the frequency converter changes its displayed graphical icons or symbols depending on the stage of the operation. Some of the icons may also be stationary in the display. For example the icon which symbols main menu may be placed in such a manner that it can be accessed all the time during the parameter set up.

According to an embodiment of the invention, the user interface of the frequency converter is a touch screen. By implementing the display panel of the frequency converter as a touch screen, the graphical icons can be directly pressed or touched such that a desired action is obtained.

The display may also be partly implemented as touch screen. In that case the icons that are to be pressed are displayed on the touch screen while other information, such as information relating to operation is displayed in conventional screen.

According to another embodiment, the display is implemented as a LCD-display with colour. The colour used in the icons may also change according to the operation of the frequency converter. For example, when the frequency converter is not operating correctly, one or more of the symbols in the display may change their colour to red. Similarly, when parameters are fed to the frequency converter using the user interface, erroneous or otherwise faulty parameters may be highlighted using a colour which is not normally used in the user interface.

According to another embodiment, the display of the frequency converter is adapted to display information using animated or consecutively changing graphical icons. In this context animated or consecutively changing refers to two or more icons that are displayed at the same place one after the other. When icons are changed in certain order, the changed icons give an impression of an animated graphical icon. An example of such an animated graphical icon is an icon with horizontally moving three dots. Depending on the wanted effect, this could be implemented using two consecutively displayed icons in which the dots are placed in different positions. Three dots are typically associated with waiting or continuing.

When a touch screen is employed, a graphical icon may change its appearance once it is touched. The change appearance gives the user feedback that the icon in question was touched. The change may last until certain action is taken or for a certain time. The feedback may be implemented by using the processor of the user interface to read the two icon images from the memory and changing the icon after the icon is touched.

It will be obvious to a person skilled in the art that, as the technology advances, the inventive concept can be implemented in various ways. The invention and its embodiments are not limited to the examples described above but may vary within the scope of the claims.

1. A frequency converter comprising a display panel, wherein the display panel is adapted to display information relating to operation or to set up of the frequency converter as graphical icons.

2. A frequency converter according to claim 1, wherein the display panel is part of the user interface of frequency converter, the user interface being adapted for inputting user commands.

3. A frequency converter according to claim 2, wherein the frequency converter comprises further a processor or similar processing means in connection with the user interface of the frequency converter and a memory readable by the processor or processing means,
the processor or processing means being
adapted to read user commands from the user interface,
adapted to read graphical icons from a memory responsive of user commands,
adapted to read operational data from the frequency converter, and
adapted to display the operational data using graphical icons.

4. A frequency converter according to claim 1, wherein the display panel is implemented at least partly as a touch screen.

5. A frequency converter according to claim 1, wherein the display panel is an LCD-panel.

6. A frequency converter according to claim 1, wherein the display is a colour panel providing coloured display.

7. A frequency converter according to claim 1, wherein one or more of the graphical icons are displayed as consecutive icons providing an animated graphical icon.

8. A frequency converter according to claim 1, wherein the graphical icons contain graphical symbols representing information on the parameters of the frequency converter or on the operation of the frequency converter.

9. A frequency converter according to claim 2, wherein the display panel is implemented at least partly as a touch screen.

10. A frequency converter according to claim 3, wherein the display panel is implemented at least partly as a touch screen.

11. A frequency converter according to claim 2, wherein the display panel is an LCD-panel.

12. A frequency converter according to claim 3, wherein the display panel is an LCD-panel.

13. A frequency converter according to claim 9, wherein the display panel is an LCD-panel.

14. A frequency converter according to claim 10, wherein the display panel is an LCD-panel.

15. A frequency converter according to claim 2, wherein the display is a colour panel providing coloured display.

16. A frequency converter according to claim 3, wherein the display is a colour panel providing coloured display.

17. A frequency converter according to claim 4, wherein the display is a colour panel providing coloured display.

18. A frequency converter according to claim 2, wherein one or more of the graphical icons are displayed as consecutive icons providing an animated graphical icon.

19. A frequency converter according to claim 3, wherein one or more of the graphical icons are displayed as consecutive icons providing an animated graphical icon.

20. A frequency converter according to claim 2, wherein the graphical icons contain graphical symbols representing information on the parameters of the frequency converter or on the operation of the frequency converter.
